(19) United States
(12) Patent Application Publication
(10) Pub. No.: US 2007/0038623 A1
(43) Pub. Date: Feb. 15, 2007

(54) METHOD AND APPARATUS TO PROVIDE ANSWERS TO A SEARCH ENGINE NATURAL LANGUAGE QUERY

(76) Inventor: Francois Huet, Santa Cruz, CA (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/463,705

(22) Filed: Aug. 10, 2006

Related U.S. Application Data
(60) Provisional application No. 60/706,982, filed on Aug. 10, 2005.

(51) Int. Cl. G06F 17/30; G06F 7/00

(52) U.S. Cl. 707/5; 707/10

(57) ABSTRACT

Methods and apparatus to enable a search engine to receive natural language queries and provide answers to user queries. The answer can be extracted from the search results. In one embodiment, the answer can be highlighted.

### CROSS REFERENCE TO RELATED APPLICATIONS

This application claims the benefit of U.S. Provisional Patent Application No. 60/706,982, filed on Aug. 10, 2005, which is incorporated herein by reference.

### STATEMENT REGARDING FEDERALLY SPONSORED RESEARCH

Not Applicable.

### BACKGROUND OF THE INVENTION

As is known in the art, when a user does a search with a conventional Internet search engine, for example, results are typically shown on a result page. Each of the items on that page represents one web page identified as a ‘hit’ that contains the information searched. Often search results present snippets of the various search results pages in which the words that were part of a user query are highlighted, and the results are displayed in an order dependent on the wording of the question. The highlighted portion of the search results typically correspond to the search key words without regard to whether the page answers the user query.

When users form their query as a natural language request it leads the search engine to highlight the word(s) of the question, but that is not what the user is most interested in. The user's interest generally lies in the answer, rather than the query.

### SUMMARY OF THE INVENTION

In general, the present invention provides methods and apparatus to enable a search engine to receive so-called natural language queries and provide answers to the user queries. The answer can be extracted from the search results, highlighted in the search results, or otherwise provided to the user.

### BRIEF DESCRIPTION OF THE DRAWINGS

The exemplary embodiments contained herein will be more fully understood from the following detailed description taken in conjunction with the accompanying drawings, in which:

FIG. 1 is a block diagram of a system to identify answers to user queries in accordance with the present invention; and

FIG. 2 is a flow chart showing an exemplary sequence of steps to identify answers to user queries in accordance with the present invention.

### DETAILED DESCRIPTION OF THE INVENTION

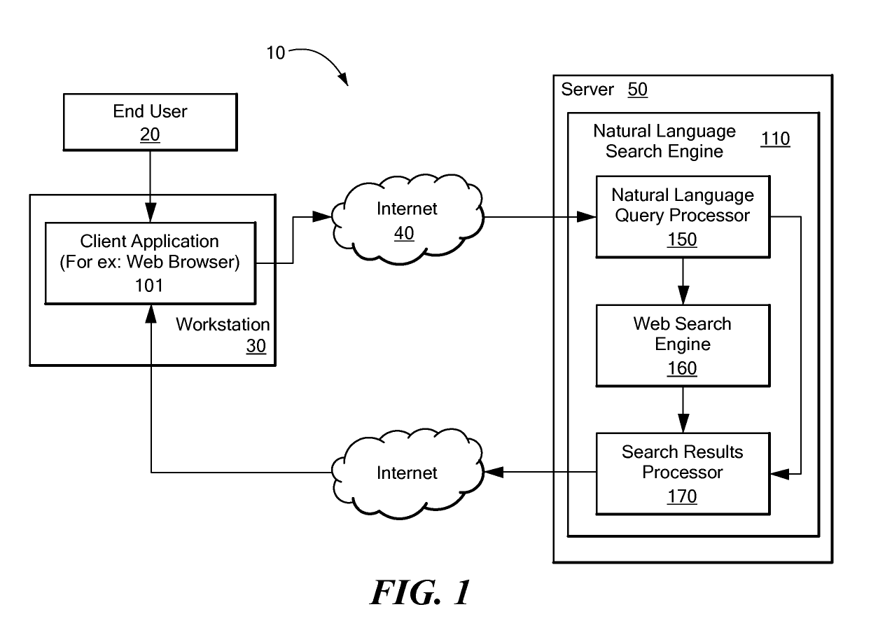

FIG. 1 shows a system 10 to enable a user 20 to interact with a workstation 30 having a client application 101, such as a Web browser, to input a search query that is transmitted via a network, 40, such as the Internet, to a server 50 having a natural language search engine 110. A natural language query processor 150 receives user queries via the Internet 40 and interacts with a web search engine 160, which interacts with a search results module 170, to provide answers to user queries, as described more fully below.

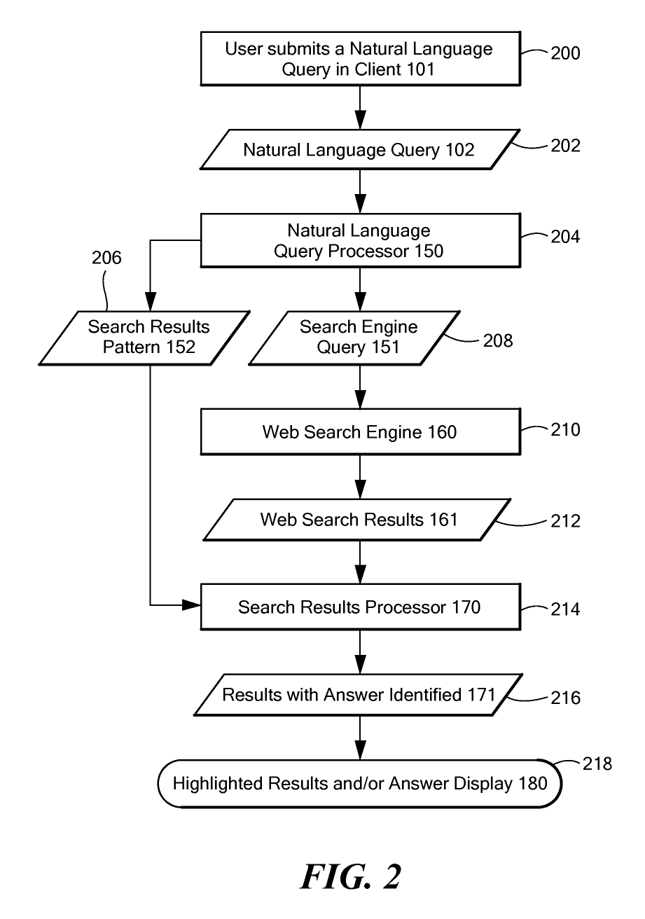

FIG. 2, in conjunction with FIG. 1, show an exemplary sequence of steps to implement query answer identification in accordance with the present invention. In step 200, a user formulates, such as by typing, a query using the user workstation 30 and generates the query in step 202. The exemplary query used is “when was Bill Clinton born?”

In step 204, this query is received by the Natural Language Query processor 150. In response to the query, the Natural Language Query processor 150 outputs one or more search engine requests in step 206 and one or more patterns in step 208 to subsequently look for in the corresponding search results. A factor representing the fitness of each pair search engine request/pattern can also be included.

The natural language query processor 150 parses the user query using one or more natural language parsing techniques. There are a variety of well known natural language parsing techniques that are suitable for the present invention.

The natural language query processor outputs search engine queries in step 208 designed for a target search engine. Each search request can be limited to a list of keywords, but can also take advantage of search engine specific features such as word proximity, synonym search, numeric ranges search, phrases with wildcards search, etc. The process can optionally assign a “fitness” to each request, allowing the results to be ordered and/or weighted.

For the example query, in one embodiment of the invention the search engine requests and corresponding fitness score is set forth below:

| Search Engine Request | Fitness |
|---|---|
| “Bill Clinton was born on” | 100 |
| “Bill Clinton” “(date of birth\|dob)” | 80 |

The fitness is calculated depending on how close the request is believed to be to the original query's meaning.

The keyword-based search engine requests of step 208 are sent to the web search engine 160 in step 210 and the web search engine generates the search results in step 212, which are sent to the search results processor 170 in step 214.

The search result patterns of step 206 are used to identify the appropriate part of the answer in the search results snippets as provided by the keyword based search engine. The patterns can take different forms and can be generated using a variety of known string search techniques. In one embodiment, so-called Regular Expressions are used. In an alternative embodiment, a token-based parser is used. These and other techniques are well known to one of ordinary skill in the art.

For the example query, in one embodiment of the invention the patterns associated with the example requests are set forth below:

| Search Engine Request | Pattern to search in the results |
|---|---|
| “Bill Clinton was born on” | Bill Clinton was born on |
| | [=Anything] DT = Adate |
| “Bill Clinton” “(date of birth\|dob)” | (date of birth\|dob) = |
| | Anything DT = Adate |

In step 214, the search results processor 170 looks for the patterns generated in step 206 in the web search results of step 212 and either highlights or extracts occurrences of the patterns in step 216 for display to the user in step 218.

In one embodiment of the invention, the complete sentence is highlighted. For the example query, an exemplary output is set forth below with a portion in bold:

Weekly Horoscopes for Bill Clinton—US Past President

. . . and actions and events in the life of Bill Clinton, since his personal birth

. . . Bill Clinton's birth date was Aug. 19, 1946, and his place of birth . . .

In another embodiment, only the exact data that was requested is highlighted. For example, an exemplary display is set forth below:

Weekly Horoscopes for Bill Clinton—US Past President

. . . and actions and events in the life of Bill Clinton, since his personal birth

. . . Bill Clinton's birth date was Aug. 19, 1946, and his place of birth . . .

In yet another embodiment of the invention, all the instances of the searched patterns are extracted and displayed separately. In a further embodiment, the search results are grouped and/or ordered based on the answer found in the search result.

While exemplary embodiments of the invention are shown and described, various modifications, substations, and alternatives will be apparent to one of ordinary skill in the art without departing from the invention.

What is claimed is:

1. A method, comprising:
processing a natural language query of a user to a search engine, and generating a keyword based search query and a pattern to be searched in the search results;
submitting the keyword based search query to the search engine;
finding occurrences of the search results pattern in the search results; and
performing formatting processing and displaying the pattern occurrences to the user.

2. The method according to claim 1, further including highlighting the search result pattern in page snippets.

3. The method according to claim 1, further including extracting the search result pattern matches and displaying the extracted search result pattern.

4. The method according to claim 1, further including extracting the search result pattern occurrences and displaying the most common value found.

5. The method according to claim 1, further including extracting the search result pattern matches, and displaying the results grouped and/or ordered by search result pattern matches similarity.

6. The method according to claim 1, wherein multiple search requests are generated, each with an associated pattern.

7. The method according to claim 1 wherein each pair “search request”/“pattern” is assigned a fitness score to order/weight the results.
